(19) United States
(12) Patent Application Publication
(10) Pub. No.: US 2026/0019499 A1
(43) Pub. Date: Jan. 15, 2026

(54) SYSTEM AND METHOD FOR SERVICE BARRING-PROCES WORKFLOW

(71) Applicant: JIO PLATFORMS LIMITED, Ahmedabad, Gujarat (IN)

(72) Inventors: Aayush BHATNAGAR, Navi Mumbai, Maharashtra (IN); Pradeep Kumar BHATNAGAR, Navi Mumbai, Maharashtra (IN); Uday SHANBHAG, Mumbai, Maharashtra (IN); Hanumant KADAM, Mumbai, Maharashtra (IN); Rishi KOUL, New Delhi (IN); Mahendra TOMAR, Madhya Pradesh (IN)

(73) Assignee: JIO PLATFORMS LIMITED, Ahmedabad, Gujarat (IN)

(21) Appl. No.: 18/992,226

(22) PCT Filed: May 29, 2024
(86) PCT No.: PCT/IN2024/050631

§ 371 Date: Jan. 8, 2025

(30) Foreign Application Priority Data
Jun. 29, 2023 (IN) 202321043820

(51) Int. Cl. H04M 3/38; H04M 3/42

(52) U.S. Cl. CPC H04M 3/382; H04M 3/42153; H04M 2203/6081

(57) ABSTRACT

The system (108) in the present disclosure for service barring workflow is designed to automate and streamline the process of managing service barring actions in a telecommunications network It provides centralized control, efficient processing. and granular control over service restrictions by implementing a method (400) involving various nodes. Tracking Area Code (TAC) and Network administrators. The system (108) offers advantages such as enhanced operational efficiency. accurate enforcement of service barring rules. real-time monitoring. and reporting capabilities. It integrates with network elements and ensures compliance with regulatory requirements. With its flexible and scalable architecture, the system (108) enables administrators and users to efficiently handle service barring requests while maintaining a positive customer experience. Overall, the system (108) for service barring workflow optimizes the service management process. enhances security, and contributes to effective network control and customer satisfaction.

This application is a national stage filing under 35 U.S.C. § 371 of International Application No. PCT/IN2024/050631, filed on May 29, 2024, which claims the benefit of priority to Indian Application No. IN202321043820, filed on Jun. 29, 2023; the contents of these applications are each incorporated herein by reference.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to the field of telecommunications and network management. More precisely, it relates to a system for service-barring process workflow and involves configuration changes on the communication nodes to ensure service barring of type or all types of services and restoring it back to original state as soon as requested.

### BACKGROUND

Background description includes information that may be useful in understanding the present invention. It is not an admission that any of the information provided herein is prior art or relevant to the presently claimed invention, or that any publication specifically or implicitly referenced is prior art.

A service barring workflow refers to the set of processes and actions involved in implementing service restrictions or blocks on specific services within a telecommunications network. It outlines the steps followed to bar or limit access to certain services for a particular user or device. While specific workflows may vary across service providers, the workflow can begin with a user request to bar a specific service, such as outgoing calls, SMS messages, data usage, or international roaming. Alternatively, predefined conditions or events may automatically trigger service barring, such as reaching a usage limit or non-payment of bills.

The user's identity is authenticated to ensure they have the necessary privilege. To request or authorize service barring. This can involve verifying user credentials, account status, or other authentication methods. The system checks the predefined policies and rules to validate whether the requested service barring aligns with the established guidelines. These policies may include barring specific services based on user profiles, subscription plans, time periods, or other criteria. Service Configuration: Once the request and policies are validated, the necessary configurations are applied to the network elements. This involves communicating with switches, routers, firewalls, or other network devices to block or restrict access to the designated services. For example, call barring can be implemented by blocking certain phone numbers or types of calls, while data barring can involve blocking specific data usage or applications.

As part of Legal compliance of operating a telecom network, there is a very important requirement which has to be met of barring a type/category or all services based on request of Law Agencies on a certain geography for a certain duration. This is a very important requirement, and any noncompliance or partial compliance may lead to huge penalties on a telecom operator. It typically involves configuration change on the node to ensure service barring of type or all types of services and restoring it back to original state as soon as requested by the Law Enforcement Agencies.

There are various existing systems and mechanisms used for service barring workflows in telecommunications networks, each with its own drawbacks. Some service providers rely on manual configuration of network elements, such as switches or firewalls, to implement service barring. This approach often requires specialized technical knowledge and manual intervention, which can be time-consuming and error-prone. It may also lack flexibility and scalability when dealing with a large number of users or complex service barring scenarios.

There are also legacy systems that were designed before advanced service barring requirements may lack robust features and flexibility. These systems may not support granular service barring options, real-time monitoring, or seamless integration with other network management components. They might have limited reporting capabilities and may be challenging to maintain or update. Service barring workflows in certain systems may suffer from delays in applying changes or updates to network configurations. This lag can lead to a window of time where service restrictions are not immediately effective, potentially allowing unauthorized access or usage until the changes are fully implemented.

There is, therefore, a need to overcome the above drawbacks and limitations in the current practices to provide an optimal solution for executing service barring workflows in telecommunications. The system in the present disclosure aims to authenticate the user and block certain services, in real-time, based on geography or any other criteria or requests from law enforcement agencies and also resume the services as required.

### OBJECTS OF INVENTION

Some of the objects of the present disclosure, that at least one embodiment herein satisfy are as listed herein below.

It is an object of the present disclosure to overcome the above limitations and drawbacks of the existing methods for implementing a service barring workflow.

It is an object of the present disclosure to control access to specific services within the network.

It is an object of the present disclosure to to set restrictions and enforce policies based on user preferences, subscription plans, usage limits, or other criteria.

It is an object of the present disclosure to facilitate the enforcement of predefined policies and rules related to service barring.

It is an object of the present disclosure to ensure that the established guidelines are followed consistently and that unauthorized or restricted services are blocked or limited as per the defined policies.

It is an object of the present disclosure to restricting access to certain services to help mitigate risks associated with unauthorized usage, fraud, abuse, or malicious activities.

It is an object of the present disclosure to helps prevent network congestion, optimize bandwidth utilization, and ensure a satisfactory quality of service for users.

It is an object of the present disclosure to allow for the customization of service barring settings based on individual user requirements, subscription plans, or regulatory restrictions.

It is an object of the present disclosure to enable efficient provisioning and configuration of network elements, automate user authentication and authorization processes, and provide real-time monitoring and reporting capabilities.

It is an object of the present disclosure to facilitate transparent communication with users regarding service barring activities.

### SUMMARY

The present disclosure discloses a system for restricting one or more services provided by a telecommunications network. The system comprises a database configured to store information pertaining to a plurality of nodes pertaining to the telecommunications network. Each of the plurality of nodes is associated with a corresponding Tracking Area Code (TAC) value indicative of the services available to each of the plurality of nodes. The system comprises an input module configured to receive an instruction to restrict the one or more services. The instruction includes a list of nodes from the plurality of nodes. In addition, the system comprises a barring module coupled to the input module. The barring module is configured to, in response to the instruction, generate a command to change the TAC value of each of the plurality of nodes with a new TAC value. Thereafter, the barring module stores the TAC values of each of the plurality of nodes and executes the command to restrict the one or more services for the list of nodes.

In an embodiment, the instruction is generated by one of a system control logic and a user.

In an embodiment, the system is configured to automatically generate the instruction when a pre-defined condition is met.

In an embodiment, the input module is further configured to validate credential information of the user. Upon successful validation, the input module is configured to confirm that the user is authorized to generate the instruction.

In an embodiment, the list of nodes is generated based on a geographical location of the nodes.

In an embodiment, the barring module is further configured to notify a service restriction start time and a service restriction end time to the list of nodes. Upon expiration of the service restriction end time, the barring module restores the TAC values of the list of nodes.

In an embodiment, the instruction includes a list of services to be restricted and duration of services. The list of services includes a voice service, a data service, a messaging service, and a multimedia service. The duration of restriction of services comprises time period during which the list of services is to be restricted.

In an embodiment, the new TAC value is associated with restricting at least one list of services and the time period of the restriction.

The present disclosure discloses a method for restricting one or more services provided by a telecommunications network having a plurality of nodes. Each of the plurality of nodes is associated with a corresponding Tracking Area Code (TAC) value indicative of the services available to each of the plurality of nodes. The method includes receiving an instruction to restrict the one or more services. The instruction includes a list of nodes from the plurality of nodes. In response to the instruction, the method includes generating a command to change the TAC value of each of the plurality of nodes with a new TAC value. Further, the method includes storing the TAC values of each of the plurality of nodes. Upon storage, the method includes executing the command to restrict the one or more services for the list of nodes.

In an embodiment, the instruction is automatically generated by a system when a pre-defined condition is met.

In an embodiment, when the instruction is generated by a user, the method further includes validating credential information of the user. Upon successful validation, confirming that the user is authorized to generate the instruction.

In an embodiment, the method further includes notifying a service restriction start time and a service restriction end time to the list of nodes. Upon expiration of the service restriction end time, restoring the TAC values of the list of nodes.

In an embodiment, the instruction includes a list of services to be restricted and duration of services. The list of services includes a voice service, a data service, a messaging service, and a multimedia service. The duration of restriction of services comprises time period during which the list of services is to be restricted.

In an embodiment, the new TAC value is associated with restricting at least one list of services and the time period of the restriction.

The present disclosure discloses a computer program product comprising a non-transitory computer-readable medium comprising instructions that, when executed by one or more processors, cause the one or more processors to receive an instruction to restrict one or more services of a list of nodes from a plurality of nodes associated with a telecommunications network. Each of the plurality of nodes is associated with a corresponding Tracking Area Code (TAC) value indicative of the services available to each of the plurality of nodes. The instruction includes a list of nodes from the plurality of nodes. Further, in response to the instruction, a command is generated to change the TAC value of each of the plurality of nodes with a new TAC value. Thereafter, the TAC values of each of the plurality of nodes are stored and the command to restrict the one or more services for the list of nodes is executed.

### BRIEF DESCRIPTION OF DRAWINGS

The specifications of the present disclosure are accompanied with drawings of the system and method to aid in better understanding of the said invention. The drawings are in no way limitations of the present disclosure, rather are meant to illustrate the ideal embodiments of the said disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates an example network architecture for a system for service barring workflow, in accordance with an embodiment of the present disclosure.

FIG. 1B illustrates an exemplary service flow diagram of a system for service barring workflow, in accordance with an embodiment of the present disclosure;

FIG. 2 illustrates an exemplary block diagram of all the modules in the processing engine of the system, in accordance with an embodiment of the present disclosure;

FIGS. 3A-3C illustrate exemplary execution instances for a service barring workflow, in accordance with an embodiment of present disclosure;

FIG. 4 illustrates an exemplary flow diagram of a service barring workflow, in accordance with an embodiment of the present disclosure; and

FIG. 5 illustrates an exemplary computer system in which or with which embodiments of the present invention can be utilized, in accordance with an embodiment of present disclosure.

### DETAILED DESCRIPTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment.

Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

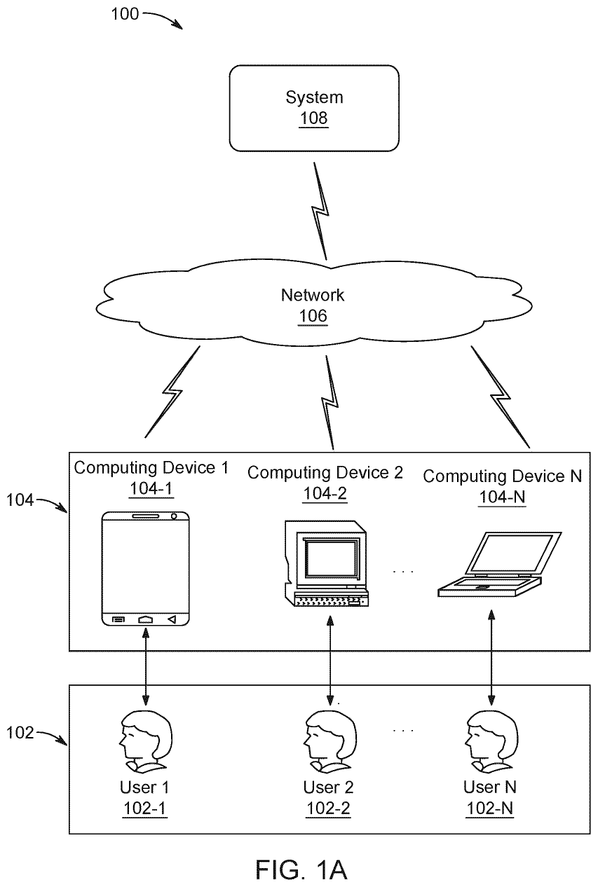

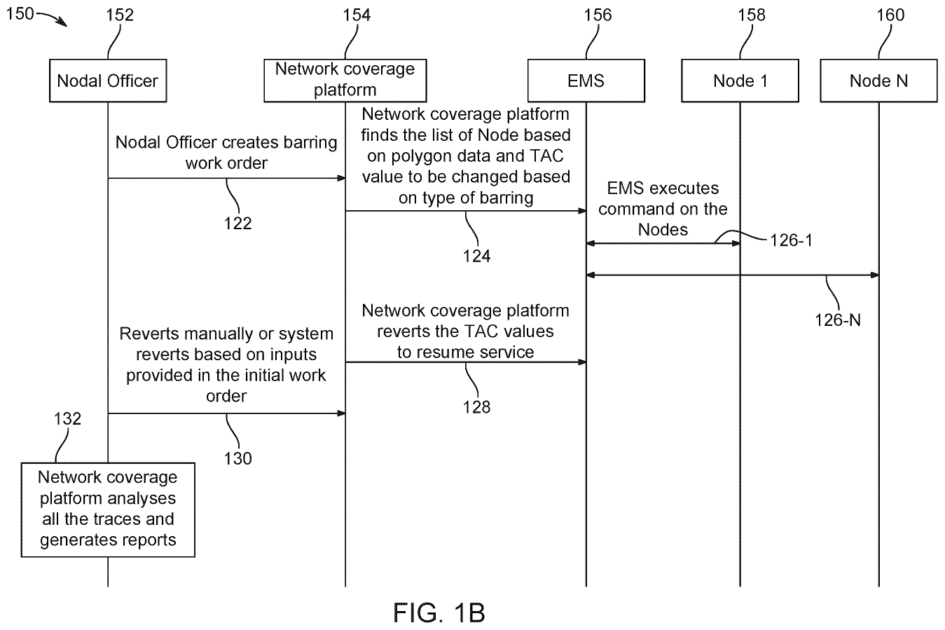

The various embodiments throughout the disclosure will be explained in more detail with reference to FIGS. 1-5.

The present disclosure relates to the field of telecommunications and network management. More precisely, it relates to a system for service-barring process workflow and involves configuration changes on the communication nodes to ensure service barring of type or all types of services and restoring it back to original state as soon as requested.

FIG. 1A illustrates an example network architecture 100 for a system for service barring workflow, in accordance with an embodiment of the present disclosure.

As illustrated in FIG. 1A, one or more computing devices (104-1, 104-2 . . . 104-N) may be connected to the system (108) for analyzing and visualizing data for a telecom network through a network (106). A person of ordinary skill in the art will understand that the one or more computing devices (104-1, 104-2 . . . 104-N) may be collectively referred as computing devices (104) and individually referred as a computing device (104). One or more users (102-1, 102-2 . . . 102-N) may provide one or more requests to the system (108). A person of ordinary skill in the art will understand that the one or more users (102-1, 102-2 . . . 102-N) may be collectively referred as users (102) and individually referred as a user (102). Further, the computing devices (104) may also be referred as a user equipment (UE) (104) or as UEs (104) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Furthermore, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

The system (108) is configured to restrict one or more services provided by a telecommunications network. The system (108) stores information pertaining to a plurality of nodes pertaining to the telecommunications network, wherein each of the plurality of nodes is associated with a corresponding Tracking Area Code (TAC) value indicative of the one or more services available to each of the plurality of nodes. A service flow of the system (108) is provided in FIG. 1B.

FIG. 1B illustrates an exemplary service flow diagram (150) of the system (108) for service barring workflow, in accordance with an embodiment of the present disclosure.

Referring to FIG. 1B, an exemplary service flow diagram (150) of the system (108) for service barring workflow is disclosed. A nodal officer (152) creates a barring work order for any particular reason, for example, due to law enforcement, etc., (step 122). The nodal officer (152) typically refers to an individual appointed by a telecom service provider or a regulatory authority to act as a point of contact for addressing customer complaints, grievances, or regulatory compliance matters. A network coverage platform (154) finds a list of nodes (for example, Node 1 (158-1) to Node N (158-N)) based on polygon data and a Tracking Area Code (TAC) to be changed based on the type of barring to the Element Management System (EMS) (step 124) (156) which executes all the commands on the nodes (step 126(1-N)). The network coverage platform (154) proceeds to revert the TAC values to resume service (step 128). The nodal officer (152) also reverts manually, and the system (108) reverts based on the inputs provided in a work order (step 130). Finally, in step (132), the network coverage platform (154) analyses all the traces and generates official reports.

In an embodiment, the network coverage platform refers to the extensive network infrastructure and technologies deployed by a telecommunication provider to provide network coverage and connectivity to its customers. The telecommunication provider operates a nationwide 4G LTE, 5G, 6G and beyond network that provides high-speed data and voice services to its subscribers. The network is built using advanced Long-Term Evolution (LTE) technology, enabling faster data speeds, improved call quality, and enhanced network capacity. The network coverage platform (154) is part of a robust network infrastructure, including a vast network of towers, base stations, and fiber optic cables. This infrastructure enables extensive coverage across both urban and rural areas, reaching previously underserved regions. The network coverage platform (154) also employs network optimization techniques to ensure efficient utilization of its infrastructure and deliver a reliable and high-quality network experience. This includes optimizing signal strength, minimizing interference, and improving network capacity to handle increasing data demands.

In an embodiment, the implementation of the system (108) is based on executing real-time service barring requests and also resuming the services on particular requests. After accepting the input from the nodal officer (152) or Network Administrator about the Node List through Direct Site Upload or geography-based selection and Type of Service to be barred along with the Duration, the system (108) generate commands to change the TAC Value on the Nodes which will discontinue the type of requested service and store the original TAC Value. When the Service Requested to be restored or the schedule service restoration time occurs, the system 108 again restores the original TAC Value. All this happens at high scale and speed thereby ensuring compliance to any Law enforcement agency requirements. Alternatively, the process of service barring involves taking an input of nodes identity directly from the Network Administrator or a geographical boundary as received from the Law Enforcement Agencies and then figure out the nodes which have coverage or serving in that geography. The system (108) also issues a barring command to the EMS with node details which normally involves changing the TAC Value, which is then used by the backend to check whether some or all services are to be barred for traffic coming from that node. The backend may refer to groups in an organization that handle the core functionality and data processing of their applications or services. In current context, the backend may refer to an application, personnel or both responsible for checking whether some or all services are to be barred for traffic coming from that node for a given TAC.

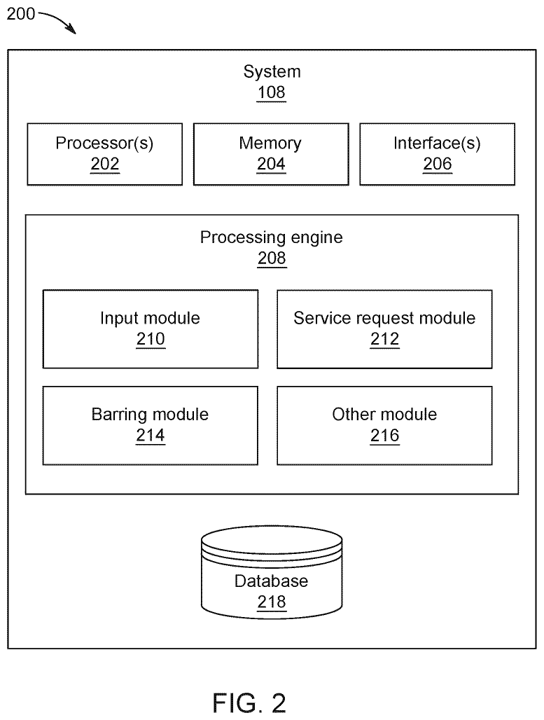

FIG. 2 illustrates an exemplary block diagram (200) of all the modules in the processing engine of the system, in accordance with an embodiment of the present disclosure.

Referring to FIG. 2, the processor 202, memory 204, an interface 206, and processing engine 208 of the system (108) focus on a service barring workflow in a telecommunications network typically involving a combination of software and hardware components that work together to perform the necessary processing tasks along with a database 218 to store all the data. The processing engine 208 includes workflow orchestration software that manages the flow of tasks and processes involved in the service barring workflow with the help of an input module 210, a service request module 212, a barring module 214 and other executing modules 216. This software coordinates the sequence of actions, validates inputs, triggers events, and ensures that the workflow progresses correctly. The processing engine 208 incorporates business rules that evaluates and enforces the predefined rules and policies related to service barring. The rules engine applies logical conditions, evaluates subscriber profiles, subscription plans, usage limits, and other parameters to determine the appropriate actions to be taken in the workflow.

In an embodiment, the input module 210 in the system (108) for service barring workflow is responsible for capturing and processing the inputs required to initiate and configure the service barring process. It allows users or automated systems to provide the necessary information and triggers to implement service restrictions. The input module typically includes a user interface that enables users to interact with the system (108) and input the required data or commands. The user as referred here is an administrator of the telecommunication organization providing the services.

This can be a web-based portal, a mobile application, or a command-line interface, depending on the design of the system (108). The input module also handles the authentication of users to ensure that only authorized individuals can access and utilize the service barring functionality. It may require users to provide login credentials, use multi-factor authentication, or integrate with identity management systems. The input module enables users to input specific parameters or conditions associated with the service barring process. This can include factors such as barring duration, usage thresholds, time-based restrictions, or conditions related to billing, payment, or user profiles. Users can provide these parameters through appropriate input fields or options. In an implementation, the input module 210 is configured to receive an instruction to restrict the one or more services. The instruction includes a list of nodes from the plurality of nodes. The instruction also includes a list of services to be restricted and duration of services, wherein the list of services comprises a voice service, a data service, a messaging service, and a multimedia service. The duration of restriction of services comprises the time period during which the list of services is to be restricted.

The instruction may be generated by a user (also referred to as a system administrator) and/or a system control logic.

In an embodiment, the service request module 212 in the present system (108) for service barring workflow is responsible for managing and processing the requests made by users or authorized entities to initiate service barring actions. It provides a structured and controlled process for users to request service barring and ensures that these requests are properly handled. The service request module 212 includes a feature connected to the user interface 206 that allows users to submit their service barring requests. This can be a web-based portal, a mobile application, or any other user-friendly interface. The interface 206 provides users with the necessary options and fields to specify the details of their service barring request. The service request module 212 presents a request form where users can provide information related to the service barring request. The form may include fields such as user identification details, service selection, duration of barring, reason for the request, and any additional comments or instructions. The service request module 212 tracks the progress of each service barring request throughout the workflow. It provides users with status updates, notifications, and information about the current stage of their request. Users can view the status of their requests and any relevant comments or actions taken by the system (108) or personnel involved.

In an embodiment, the barring module 214 is responsible for implementing the actual service restrictions or blocks based on the approved requests or triggers and also includes all the logical and business rules. The barring module 214 is configured to, in response to the instruction received by the input module 210, generate a command to change the TAC value of each of the plurality of nodes, with a new TAC value. Thereafter, the barring module 214 stores the TAC values of each of the plurality of nodes and executes the command to restrict the one or more services for the list of nodes. The barring module 214 is further configured to notify a service restriction start time and a service restriction end time to the list of nodes. Upon expiration of the service restriction end time, the barring module restores the TAC values of the list of nodes.

The barring module 214 applies the predefined policies and rules related to service barring. It ensures that the requested service restrictions align with the authorized permissions, subscription plans, usage limits, or regulatory requirements. The module enforces these policies to block or limit the specified services accordingly. The barring module 214 manages the configuration of network elements, such as switches, routers, firewalls, or gateways, to implement the service restrictions. It communicates with these network elements to configure the necessary rules or filters that block or limit the designated services for the affected subscribers. The barring module 214 enables real-time control and monitoring of the service restrictions. It continuously evaluates the status and usage patterns of the restricted services and takes appropriate actions to ensure compliance with the barring rules. This includes blocking or limiting service access based on subscriber activity or usage thresholds. The other executing modules 216 are responsible for other executing processes of the processing engine.

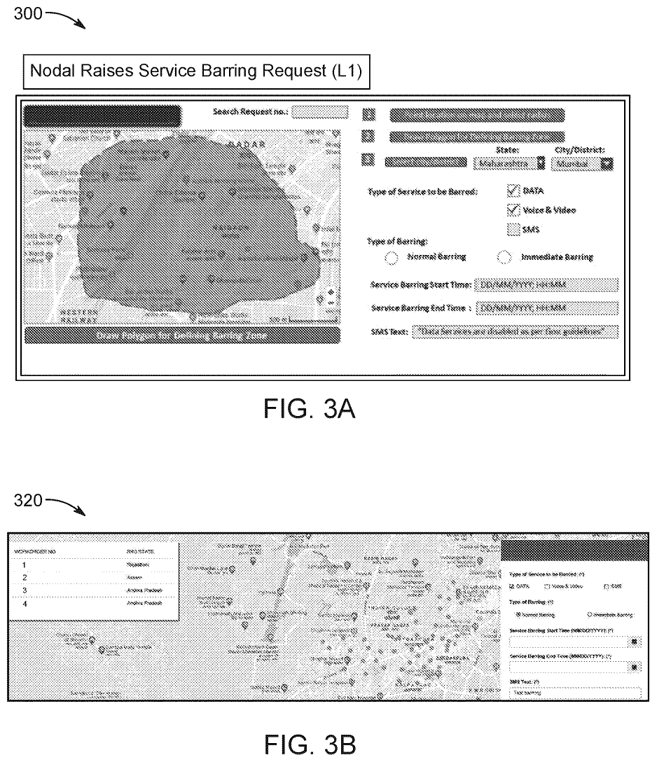

FIGS. 3A-3C illustrate exemplary execution instances (300, 320 and 330) for a service barring workflow, in accordance with an embodiment of present disclosure.

As illustrated, in FIG. 3A, representation or an exemplary execution instance of a geography-based barring work order is disclosed (300). There is a Nodal Raises Service Barring Request raised by the users (administrators) to block services in a particular geographical region. The user can choose a normal barring that takes some time to execute after following all standard procedures or can select an option of immediate barring. The user can also pin a point location on the map and select a particular radius to cover in the form of a polygon for flexibility of selection of region. The user can select the type of service to be barred including a data service, a voice or video service or an SMS service. This selection is done in a confidential manner after authenticating the identity of the user because of the severity of the barring of service workflow. As shown in FIG. 3A, the user can select dropdown options to select the region, for example, state, district, etc. Further, the user can use radio buttons for barring services (for example, data, voice, SMS), and type of barring (for example, normal barring or immediate barring). Further, the user can define using the GUI option to start service barring start time and service barring end time. In examples, the user can also send a message indicating why the services are barred.

In an embodiment, the authentication of the users in the system (108) for service barring workflow is a crucial component to ensure that only authorized individuals have access to the system (108) and can initiate or manage service barring actions. The system (108) typically requires users to provide unique identifiers, such as usernames or email addresses, and associated passwords or passphrases. Users must authenticate themselves by providing the correct combination of credentials to gain access to the system (108). The system (108) also includes a Multi-Factor Authentication (MFA) which adds an extra layer of security by requiring users to provide multiple pieces of evidence to authenticate their identity. This can include something the user knows (password), something the user possesses (security token or smart card), or something the user is (biometric data like fingerprint or facial recognition). MFA helps mitigate the risk of unauthorized access, even if passwords are compromised. The specific authentication methods and techniques employed in a service barring workflow system (108) may also depend on the system 108′s design, security requirements, and the organization's policies. It implements robust authentication measures to protect against unauthorized access and ensure the integrity of the service barring workflow.

As illustrated, in FIG. 3B, a map of the geographical region of service barring workflow is disclosed (320). A particular work order number is assigned to each service barring request coming from any state or region. Once the type of service to be barred and the type of barring is confirmed, the system (108) includes a service barring start time and a service barrier end time and notifies the subscriber based by SMS or any other selected mode. The barring process starts and coordinates the various steps and actions. This includes initiating the necessary tasks, assigning responsibilities to the appropriate personnel, and defining the sequence of actions to be performed. The system (108) evaluates the relevant policies and rules associated with the service barring. This may involve checking usage limits, subscription details, subscriber profiles, and any other conditions that determine the applicability of the barring action. The policy evaluation ensures that the requested barring aligns with the defined rules and regulations. The system (108) also configures the necessary network elements and system (108) to implement the service barring. It communicates with network switches, routers, firewalls, or gateways to apply the required restrictions on the specified services. This configuration ensures that the barring is enforced effectively in the telecommunications network.

As illustrated, in FIG. 3C, a list of all the work orders is disclosed (330). The work orders include a status code of whether it is in progress or not and the zone in which it is to be executed such as the North, South, East or West zone. The circle is also specified depending on the zone and the geographical region along with a work order ID and a domain. The details for the service barring workflow request are detailed in the report including the submission time, the schedule for execution of the request, the execution time, the cell count and the percentage of task completion. The list can be extensive as it covers a large geographical region covering all operating zones. This list is important for keeping a track of all the service request being executed and the time duration for the same.

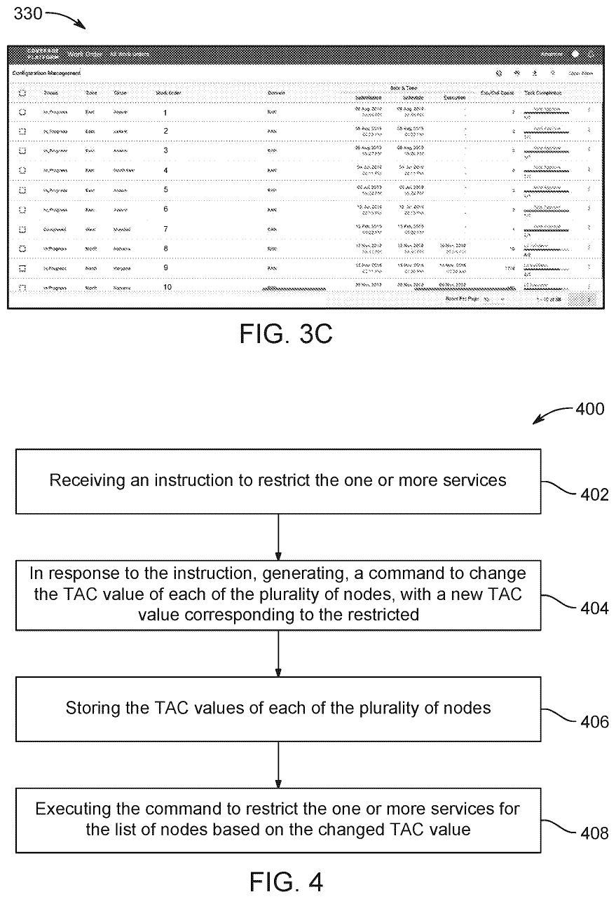

FIG. 4 illustrates an exemplary flow diagram of a service barring workflow or a method for restricting one or more services provided by a telecommunications network having a plurality of nodes, in accordance with an embodiment of the present disclosure.

Each of the plurality of nodes is associated with a corresponding Tracking Area Code (TAC) value indicative of the services available to each of the plurality of nodes. As per the method an instruction to restrict the one or more services is received. In an implementation, the instruction may be automatically generated by a system when a pre-defined condition is met. For example, the pre-defined condition may be entering into a restricted area (where government has placed restrictions), usage limits of subscriber, failure to pay usage bills, etc. In another implementation, the instruction is generated by a user. In this scenario, the system validates the credential information of the user. Upon successful validation, it is confirmed that the user is authorized to generate the instruction.

The instruction includes a list of nodes from the plurality of nodes. The instruction also includes a list of services to be restricted and duration of services, wherein the list of services comprises a voice service, a data service, a messaging service, and a multimedia service. The duration of restriction of services comprises the time period during which the list of services is to be restricted. In response to the instruction, a command to change the TAC value of each of the plurality of nodes with a new TAC value is generated. The new TAC value is associated with restricting at least one list of services and the time period of the restriction. The original TAC values of each of the plurality of nodes are stored and the command to restrict the one or more services for the list of nodes is executed.

Upon execution of the command, the list of nodes is notified about a service restriction start time and a service restriction end time. Upon expiration of the service restriction end time, the original TAC values of the list of nodes are restored.

As illustrated, in FIG. 4, an exemplary flow diagram 400 of the entire service barring workflow process is disclosed. The first step is to receive through an input module (210) an instruction to restrict the one or more services (step 402). The instruction includes a list of nodes from the plurality of nodes. The list of services may include voice service, data service, messaging service, etc. The instruction may be from the network Administrator or network controller. The workflow can begin with a user (administrator) request to bar a specific service, such as outgoing calls, SMS messages, data usage, or international roaming. Alternatively, predefined conditions or events may automatically trigger service barring, such as reaching a usage limit, non-payment of bills or entering a restricted area. The user's identity is authenticated to ensure they have the necessary privileges to request or authorize service barring. This can involve verifying user credentials, account status, or other authentication methods. The network administrator provides a list of node identities to the system (108). These node identities can represent specific network elements such as switches, routers, or gateways that need to be involved in the service barring process. The administrator can provide this information through a user interface, a configuration file, or an API. Alternatively, the network administrator can define geographical boundaries for the service barring. This can be in the form of geographic coordinates, area codes, city names, or any other relevant geographical identifiers. The system (108) uses this information to identify the specific regions or areas where the service barring actions should be applied.

As illustrated, in FIG. 4, in a service barring workflow, disclosing the nodes that have coverage or are serving in a particular geographical region can be useful for various purposes, such as determining the impact of service barring actions or identifying potential areas for service restrictions. The service barring workflow system (108) can maintain a geographic mapping component that associates node identities or network elements with specific geographical regions. This mapping can be created and updated by the network administrators based on their knowledge of the network infrastructure. The system (108) can maintain an inventory of network nodes and their corresponding coverage areas. This inventory can include details such as node identifiers, geographical coordinates, service coverage information, and any other relevant attributes. The system (108) associates each node in the inventory with the corresponding geographical regions it serves or covers. In the service barring workflow, users can query the system (108) by specifying a particular geographical region of interest. The system (108) can then retrieve and disclose the nodes that have coverage or are serving in that specific region. The system (108) can generate reports or provide visual representations, such as maps or charts, to disclose the nodes serving in the specified geographical region. These reports or visualizations can include information about the node identities, their coverage areas, and any additional relevant details.

As illustrated, in FIG. 4, the service barring system (108), upon receiving the request for service barring, would typically interact with the EMS responsible for managing the network nodes. The system (108) would generate the necessary commands or instructions to be sent to the EMS for the service barring action. The service barring system (108) can have access to the relevant node details, such as the unique node identifiers, IP addresses, or other identifiers specific to the EMS. These details would be used to identify the target nodes for the service barring. The service barring workflow system (108) generates the appropriate barring command specific to the EMS being used. The command may include parameters such as the type of service to be barred, the duration of the barring, or any other relevant parameters required by the EMS. The service barring system (108) through the barring module, in response to the instruction, generates a command to change the TAC value of each of the plurality of nodes, with the new TAC value corresponding to the restricted services (step 404). In some examples, the new TAC value may be generated by the backend. In examples, a TAC value may refer to the specific identifier assigned to a Tracking Area Code (TAC). Each TAC value uniquely identifies a tracking area within the network. The TAC value may be a numerical or alphanumeric code that is used by mobile devices to indicate their current location area to the network. When a mobile device moves from one tracking area to another, it communicates its current TAC value to the network during the location update process. The network then uses this information to update the device's location in its database and to route incoming calls, messages, or data to the appropriate base station serving that tracking area. The TAC values are managed and assigned by the network operator as part of the network configuration. They are used to optimize network performance, manage handovers between base stations, and track the movement of mobile devices within the network. In examples, the new TAC value may be associated with restrictions on at least one list of services and the time period of the restriction. The backend team may define the restriction associated with the new TAC value and its corresponding duration. On the other hand, TAC is a unique identifier used in cellular telecommunications networks to identify a geographic area within which mobile devices can move without triggering a location update. The nodes in a given geographic area may have a TAC. Referring back, the command is communicated to the EMS. The TAC values of each of the plurality of nodes are stored (step 406).

As illustrated, in FIG. 4, the next step is to determine whether some or all services are to be barred for traffic coming from a specific node using the TAC value. The backend of the service barring system (108) receives incoming traffic from various nodes, including the node identified by its TAC value. The system (108) extracts the TAC value from the incoming traffic. This could be done by examining specific fields or headers in the network packets or messages. The system (108) performs a lookup operation to match the extracted TAC value with the predefined database or reference information that associates TAC values with service barring rules or configurations. Based on the lookup result, the system (108) determines whether some or all services should be barred for the traffic originating from the node with the corresponding TAC value. The rules or configurations associated with the TAC value will specify the specific services to be barred. If the lookup determines that service barring is required, the system (108) applies the appropriate service barring actions to the incoming traffic by executing the command to restrict the one or more services for the list of nodes based on the changed TAC values (step 408). This can involve blocking or limiting access to the designated services for the traffic originating from the specific node. After the service barring is applied, the system (108) routes the traffic according to the configured rules or policies. The barred services will be restricted or denied for the traffic originating from the node with the matching TAC value. The nodes as described herein may include, but are not limited to nodeB, eNB (Evolved Node B), gNB (Next-Generation Node B), Access Point (AP), etc. The NodeB in Universal Mobile Telecommunications System (UMTS) systems is the base transceiver station responsible for radio transmission and reception. It connects mobile devices to the core network and manages radio resources within its coverage area. The eNB is the base station responsible for radio communication with user equipment (UE), such as smartphones and tablets. It supports high data rates, low latency, and improved spectral efficiency compared to earlier technologies. The gNB is a 5G (Fifth Generation) network node. The gNB is the base station that provides wireless access to user equipment. It supports advanced features such as massive MIMO (Multiple Input Multiple Output), beamforming, and dynamic spectrum sharing to deliver high-speed, low-latency connectivity. The AP are devices that provide wireless connectivity to client devices, such as laptops, smartphones, and IoT (Internet of Things) devices, within a local area network (LAN). They are commonly used in Wi-Fi networks to extend network coverage and provide internet access.

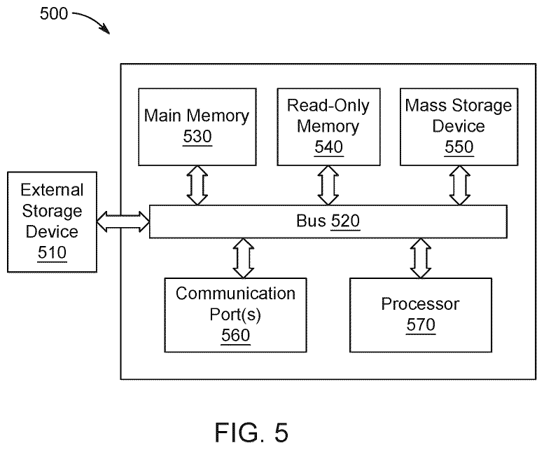

FIG. 5 illustrates an exemplary computer system (108) in which or with which embodiments of the present invention can be utilized, in accordance with an embodiment of present disclosure.

Referring to FIG. 5, a block diagram of an exemplary computer system (108) is disclosed. As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device, may also be coupled to the bus (520) to support direct operator interaction with the computer system (500). Other operator and administrative interfaces can be provided through network connections connected through the communication port(s) (560). The components described above are meant only to exemplify various possibilities. In no way should the aforementioned exemplary computer system (500) limit the scope of the present disclosure.

In an embodiment, a processor (202) of the system (108) is used to process all the data that is required for service barring process workflow. A person skilled in the art will appreciate that the system (108) may include more than one processor 202 and communication ports for ease of function. Examples of processors 202 include, but are not limited to, an Intel® Itanium® or Itanium 2 processor(s), or AMD® Opteron® or Athlon MP® processor(s), Motorola® lines of processors, FortiSOC™ system on a chip processor or other future processors. The processor 202 may include various modules associated with embodiments of the present invention. The input component can also include communication ports, ethernet ports, gigabit ports, parallel port, or another Universal Serial Bus (USB). The communication port can also be chosen depending on a specific network such as a Wide Area Server (WAN), Local Area Network LAN), or a Personal Area Network (PAN). The communication port can be an RS-232 port that can be used with the remote dialing and internet connection options of the system (108). A Gigabit port can be used to connect the system (108) to the internet at all times. And the Gigabit port can use copper or fibre for connection.

It is to be appreciated by a person skilled in the art that while various embodiments of the present disclosure have been elaborated for implementing a service-barring workflow. However, the teachings of the present disclosure are also applicable for other types of applications as well, and all such embodiments are well within the scope of the present disclosure. However, the system (108) and method for sign language conversion is also equally implementable in other industries as well, and all such embodiments are well within the scope of the present disclosure without any limitation.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While considerable emphasis has been placed herein on the preferred embodiments it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The proposed invention provides a system for efficiently executing system barring workflows.

The proposed invention provides a system that provides centralized control and management of service barring actions.

The proposed invention provides a system that automates and streamlines the service barring workflow, reducing manual intervention and potential errors.

The proposed invention provides a system that automates the workflow and reducing manual tasks and improves operational efficiency.

The proposed invention provides a system that eliminates repetitive manual efforts, enabling administrators to handle a higher volume of service barring requests and reducing the time required for each request.

The proposed invention provides a system that allows user (administrator) to specify the exact services, duration, and scope of the barring for each request, ensuring precise enforcement of restrictions based on user requirements or policy guidelines.

The proposed invention provides a system that can monitor the status of ongoing service barring actions, track usage patterns, and generate reports for auditing, analysis, and compliance purposes.

The proposed invention provides a system that incorporates robust authentication mechanisms, access controls, and permission settings to prevent unauthorized access or modifications to the workflow.

The proposed invention provides a system that can accommodate changes in service offerings, network infrastructure, or regulatory guidelines, allowing the user (administrator) to configure new barring rules or modify existing ones as needed.

The proposed invention provides a system that can integrate with network elements such as switches, routers, or gateways, enabling seamless communication and configuration changes required for service barring.

1. A system for restricting one or more services provided by a telecommunications network, the system comprising:
a database configured to store information pertaining to a plurality of nodes pertaining to the telecommunications network, wherein each of the plurality of nodes is associated with a corresponding Tracking Area Code (TAC) value indicative of the one or more services available to each of the plurality of nodes;
an input module configured to:
receive an instruction to restrict the one or more services, wherein the instruction includes a list of nodes from the plurality of nodes; and
a barring module coupled to the input module, the barring module is configured to:
in response to the instruction, generate a command to change the TAC value of each of the plurality of nodes with a new TAC value;
store the changed TAC values of each of the plurality of nodes in the database; and
execute the command to restrict the one or more services for the list of nodes based on the changed TAC value.

2. The system as claimed in claim 1, wherein the instruction is generated by one of a system control logic and a user.

3. The system as claimed in claim 2, wherein the system automatically generates the instruction when a pre-defined condition is met.

4. The system as claimed in claim 2, wherein the input module is further configured to:
validate credential information of the user; and
upon successful validation, confirm that the user is authorized to generate the instruction.

5. The system as claimed in claim 1, wherein the list of nodes is generated based on a geographical location of the nodes.

6. The system as claimed in claim 1, wherein the barring module is further configured to:
notify a service restriction start time and a service restriction end time to the list of nodes; and
upon expiration of the service restriction end time, restore the TAC values of the list of nodes.

7. The system as claimed in claim 1, wherein the instruction comprises a list of services to be restricted and duration of services, wherein the list of services comprises a voice service, a data service, a messaging service, and a multimedia service, and wherein the duration of restriction of services comprises time period during which the list of services is to be restricted.

8. The system as claimed in claim 7, wherein the new TAC value is associated with restricting at least one list of services and the time period of the restriction.

9. A method for restricting one or more services provided by a telecommunications network having a plurality of nodes, each of the plurality of nodes is associated with a corresponding Tracking Area Code (TAC) value indicative of the one or more services available to each of the plurality of nodes, the method comprising:
receiving, by an input module, an instruction to restrict the one or more services, wherein the instruction includes a list of nodes from the plurality of nodes; and
in response to the instruction, generating, by a barring module, a command to change the TAC value of each of the plurality of nodes with a new TAC value;
storing the changed TAC values of each of the plurality of nodes in the database; and
executing the command to restrict the one or more services for the list of nodes based on the changed TAC value.

10. The method as claimed in claim 9, wherein the instruction is automatically generated by one of a system control logic and a user when a pre-defined condition is met.

11. The method as claimed in claim 10, when the instruction is generated by the user, the method further comprising:
validating, by the input module , credential information of the user; and
upon successful validation, confirming that the user is authorized to generate the instruction.

12. The method as claimed in claim 9, wherein the list of nodes is generated based on a geographical location of the nodes.

13. The method as claimed in claim 9, the method further comprising:
notifying, by the barring module, a service restriction start time and a service restriction end time to the list of nodes; and
upon expiration of the service restriction end time, restoring the TAC values of the list of nodes.

14. The method as claimed in claim 9, wherein the instruction comprises a list of services to be restricted and duration of services, wherein the list of services comprises a voice service, a data service, a messaging service, and a multimedia service, and wherein the duration of restriction of services comprises time period during which the list of services is to be restricted.

15. The method as claimed in claim 9, further comprising associating the new TAC value with restriction on at least one list of services and the time period of the restriction.

16. A computer program product comprising a non-transitory computer-readable medium comprising instructions that, when executed by one or more processors, cause the one or more processors to execute a method for restricting one or more services provided by a telecommunications network having a plurality of nodes, each of the plurality of nodes is associated with a corresponding Tracking Area Code (TAC) value indicative of the one or more services available to each of the plurality of nodes, the method comprising:
receiving, by an input module, an instruction to restrict the one or more services, wherein the instruction includes a list of nodes from the plurality of nodes; and
in response to the instruction, generating, by a barring module, a command to change the TAC value of each of the plurality of nodes with a new TAC value;
storing the changed TAC values of each of the plurality of nodes; and
executing the command to restrict the one or more services for the list of nodes based on the changed TAC value.

17. (canceled)
